(19) United States
(12) Patent Application Publication
(10) Pub. No.: US 2011/0222522 A1
(43) Pub. Date: Sep. 15, 2011

(54) Radio Station System for a Wireless Network

(75) Inventors: Yahya AKIL, Karlsruhe (DE); Kai Benjamins, Karlsruhe (DE); Stefan Keller, Karlsruhe (DE); Jörg Müller, Linkenheim (DE); Manfred Wolf, Vilseck (DE)

(73) Assignee: Siemens Aktiengesellschaft, Munchen (DE)

(21) Appl. No.: 13/046,349

(22) Filed: Mar. 11, 2011

(30) Foreign Application Priority Data
Mar. 12, 2010 (EP) EP10002645

(51) Int. Cl. H04W 84/02

(52) U.S. Cl. 370/338

(57) ABSTRACT

A radio station system for a wireless network with at least two access network nodes, wherein a first of the at least two access network node is assigned to the radio station system as an access network node in the wireless network and the radio station system is connected to the first access network node over an active radio link for the transmission of user data. During the existence of the active radio link between a first radio station and the first access network node, a second radio station transmits or exchanges no user data via a radio link with an access network node in the wireless network and at least at times identifies available access network nodes in the wireless network for the radio station system.

### BACKGROUND OF THE INVENTION

1. Field of the Invention

The present invention relates to a radio station system for a wireless network, i.e., for an automation, real time and/or industrial wireless network, with at least two access network nodes, where a first of the at least two access network nodes is assigned to the radio station system as an access network node in the wireless network and the radio station system is connected to the first access network node over an active radio link for the transmission of user data.

2. Description of the Related Art

In general, radio station systems are known. For example, US Publication No. 2006/0221993 A1 discloses a wireless local area network (WLAN) with a multiplicity of access network nodes designated “access points” and a multiplicity of radio stations in the radio coverage area of the access points. Here, an access point selects a free frequency from a multiplicity of available frequencies, on which it then communicates with the radio stations located within its radio coverage area. In order to prevent interference between the different access points in the network, the different access points communicate with their respectively assigned radio stations on different WLAN channels, which are assigned to different radio frequencies. In order to locate a suitable access point as an access network node, the radio stations in the wireless network regularly scan the different WLAN channels, i.e., the different WLAN frequencies, to discover based on the signals received, where a suitable access network node is located or whether a better access network node than the currently assigned access network node is connected in the wireless network.

If such a better access network node is located the radio station then starts a procedure to establish a radio link (if applicable) while additionally undertaking an authentication procedure for example according to the Standard IEEE 802.11i.

It is a disadvantage of conventional systems that the aforementioned period for establishing a radio link, i.e., if an authentication step is involved, takes a relatively long time. This can in particular then become problematic, if the setting-up of a radio link to a new access point becomes necessary through the loss of the old radio link, such as due to the movement of the radio station, and during the setting-up of the new connection no user data whatsoever can be transmitted.

### SUMMARY OF THE INVENTION

It is thus an object of the present invention to achieve faster handover from an existing radio link in a wireless network to a newly set-up connection.

This and other objects and advantages are achieved in accordance with the invention by providing a radio station system in which, while a first radio station of the radio station system is already operating an active radio link for the exchange of user data to be transferred from the radio station system, a second radio station of the radio station system is seeking and identifying the available access network node in the wireless network for the radio station system, and is thus not subjected to a load from the parallel existence of a radio link for the exchange of the user data. Here, it is already possible, in parallel to the existing user data connection, to identify further access network nodes and possibly to initiate a communication with the further access nodes. In this way, the radio station system can already prepare a possible change to a further access network node and then more rapidly effect such a change if necessary.

The wireless network can, for example, comprise a WLAN network, for example, in accordance with the Standard IEEE 802.11, as a WiMAX network, for example, in accordance with the Standard IEEE 802.16 and/or comparable wireless networks. Furthermore, the wireless network can also be configured as a wireless field bus system, for example, in accordance with the “Wireless HART” Standard. The wireless network can also be configured as a wireless communication system, for example, according to the GSM, UMTS or the GPRS Standard or similar standards.

An access network node can, for example, be configured as a “WLAN access point” in the case of a WLAN network, or in the case of a communication network, for example, as a base station. An access network node comprises at least, among other features, the function that it serves or can serve as a communication partner for a radio station located in the wireless network, where the radio station then, for example, can or does transmit user data through the access network node to a correspondingly provided communication partner, for example, within the wireless network or outside of the wireless network.

The radio station system or a radio station can, for example, be configured in the case of a WLAN network as a “WLAN client”, or generally as a comparable arrangement. In general, every transmit/receive arrangement set up and configured for communication with the access network node can be regarded as a radio station system or radio station. Radio systems or the radio station system, in general, have at least one transmit/receive unit for the transmission of data to a receiver and/or the reception of data from a transmitter.

The radio station system can be connected to the first access network node over an active radio link for the transmission of user data or also for the exchange of the user data. Furthermore, control data, for example, for establishing and controlling the active radio link, for authentication, and/or also for other information and setting-up purposes, can also be transmitted or exchanged over the active radio link.

In this connection, user data will be the data actually to be transmitted from a first communication partner to a second communication partner over the wireless network. Such user data can, for example, be general information data, audio, image and/or video data, text data, measurement data, setting-up data, control data and/or similar data. Not classed as user data is, for example, communication control data exchanged between the radio station or the radio station system and an access network node for setting up or establishing the communication link. Here, one unit notifies the other, for example, at which frequency or on which channel certain data transmissions take place and the like. In the present description, such data is designated radio communication control data.

The communication interface for connection of the first to the second radio station can, for example, be an Ethernet interface or any further wireless or wired, parallel or serial interface, for example, a point-to-point connection.

The fact that the radio station system or the second radio station at least at times identifies available access network nodes in the wireless network means, for example, that the second radio station performs such access network node searches regularly and/or according to a predefined or predefinable time pattern. Here, the second radio station, for example, can check all the communication channels available in the wireless network for possible signals from an access network node and analyze them according to their sender. For example, after a check on a portion of the possible radio channels or also only on a radio channel particularly suitable for selection of available access network nodes, or also all possible radio channels, the second radio station can then put together the available access network nodes thereby identified, if applicable, for example, with a reception quality of the messages received from the respective access network node.

In an advantageous embodiment of the invention, the second radio station is configured to determine a preferred access network node from the available access network nodes identified and to set up a standby connection with the preferred access network node. Here, the standby radio link can be set up such that at least during the existence of the active radio link between the first radio station and the first access network node, no user data is exchanged over the standby radio link. As a result, the transmission of user data from the radio station system to the access network node in the wireless network during the existence of the standby connection occurs only over the active radio link of the first radio station with the first access network node. Radio communication control data according to the present embodiment can, however, also be transmitted over the standby radio link, for example, for setting-up and/or control of the standby radio link.

The presently contemplated embodiment has the advantage that during the existence of the active radio link for user data transmission, all the procedures for establishing a radio link with the preferred access network node can already be performed in parallel by the second radio station. If there is a requirement for a switchover of the connection (for example, in the case of a “handover” to the preferred access network node), then the new channel does not have to be established in a time-consuming process, but instead the established standby connection can be used. This allows significantly faster switchover of the radio station system to a different access network node.

Here, the preferred access network node can be a further access network node in the wireless network differing from the first access network node. The preferred access network node can, however, also be the first access network node. In this case, the preferred access network node can also be provided for the second radio station of the radio station system to form a standby connection to the first access network node. In particular, in the case of a mobile radio station system, mounted, for example, in a vehicle, in the case of which, for example, the first and second radio station are provided at a distance from each other and/or with different antennae characteristics, the situation can arise where the active radio link between the first radio station and the first access network node deteriorates or even fails completely, while a radio link between the first access network node and the second radio station of the radio station system still remains possible.

Determination of the preferred access network nodes can, for example, occur by comparing the input intensities or input field strengths of the message signals coming from the different access network nodes, possibly also taking into account other criteria, such as protocol standards or security standards of the respective access network node. Here, the determination of the preferred access network node can, for example, occur such that the access network node suitable for the radio station system at the respective time of determination is identified. Additionally, during the existence of a standby radio link, the second radio station can further identify available access network nodes in the wireless network. If an even more suitable access network node should be identified, this more suitable access network can be set up as an additional standby radio link and the existing standby radio link then discontinued once more. In this way, changes to the wireless network, for example, caused by movement of the radio station system or the commissioning or modification of further access network nodes can be taken into account dynamically at any time.

The radio station system, i.e., the second radio station, can furthermore be configured to compare a quality of the active radio link with a quality of the standby radio link. With such a comparison, it is possible, for example, to assess whether instead of the existing, active radio link of the radio station system a better possibility for connection of the radio station system exists within the wireless network.

Here, the quality of the respective radio link can be determined, for example, based on a signal strength or signal intensity of the message signals received from the access network node. Furthermore, other criteria, such as time jitter or noise strength, can also be taken into account.

The radio station system, i.e., the second radio station, can also be configured to select a preferred radio link for the active radio link and the standby radio link. Consequently, the radio station system can then decide which of the channels is most suitable for the user data transmission.

Such a selection of the preferred radio link can, for example, occur based on the aforementioned qualities of the respective radio link, under certain circumstances taking into account further criteria, such as the protocols supported, real-time capabilities or security standards of the respective access network node. Furthermore, the selection can also occur based on other criteria, such as an operator set-up.

In an advantageous embodiment the radio station system is configured and set up such that the standby radio link is converted into a further active radio link for the transmission of the user data from the second radio station to the preferred access network node. Here, the active radio link between the first radio station and the first access network node is also then terminated or converted into a further standby radio link, so that after this process, the user data transmitted over the radio station system to an access network node in the wireless network is now only transmitted over the further active radio link.

The further standby radio link and/or the aforementioned additional standby radio link can, for example, be configured to correspond to a standby radio link in accordance with the presently disclosed embodiments. In particular, no user data is exchanged over the further standby radio link and/or the additional standby radio link according to the present description. Nevertheless, radio communication control data and/or authentication data, for example, can be transmitted or exchanged over these standby radio links.

The above-described switching process can occur, for example, if the quality of the standby radio link exceeds the quality of the active radio link and/or the preferred radio link corresponds to the standby radio link. The two criteria cited can, for example, be criteria or indices for the fact that the preferred radio link is the more suitable connection for transmission of the user data for the radio station system compared with the active radio link.

Such a switchover of the radio station system from the active radio link to the further active radio link can also occur, for example, if the quality of the standby radio link has exceeded the quality of the active radio link for a particular period of time. In this way, it can better be ensured that this is not just a matter of a short term quality advantage, but a longer-term quality advantage, so that the aforementioned switchover and the corresponding effort are also worthwhile.

A radio station system configured in accordance with the disclosed embodiments enables significantly faster switchover of a user data link from the active radio link of the first radio station for the first access network node to the further active radio link of the second radio station for the preferred access network node. In that the standby radio link between the second radio station of the radio station system and the preferred access network node already existed before the switchover, it is no longer necessary to undertake the time-consuming process of switchover, setting up the channel and if applicable performing an authentication upon switchover, but instead the standby radio link already established can be used. In this way, a “handover” to the preferred access network node can be achieved very rapidly.

The first radio station can furthermore be configured and set up such that after such a switchover of the radio links, or as the case may be “handover” of the radio station system, the first radio station at least at times and/or regularly identifies available access network nodes in the wireless network for the radio station system.

Furthermore, the first radio station can be configured such that after such a switchover, no further user data is transmitted over radio links of the first radio station. In particular, the first radio station can be configured to correspond to the second radio station in accordance with the presently disclosed embodiment and/or the second radio station can be configured to correspond to the first radio station as described.

In this way, for example, a radio station system can be created, in which the first and second radio station have swapped their original roles after a handover, as described above. Here, the radio station system then furthermore demonstrates the advantages of the original radio station system for the transmission of user data and the parallel handling of a standby connection.

The antennae of the first and second radio station can, for example, be located at a distance from each other and/or have different radiation characteristics. The distance between the radio stations can, for example, be 1 meter, 10 meters, 50 meters or even 100 meters.

The presently contemplated embodiment enables a better radio field coverage by the radio station system to be achieved, because the likelihood is increased that a suitable access network node can be located at least in the reception area or radius of reception of one of the radio stations or one of the antennae of the radio stations.

In another embodiment, the first and second radio stations are each provided with a housing, where the housings of the first and second radio stations can also be at a distance from each other. Here, the distance can also, for example, be 1 meter, 10 meters, 50 meter or even 100 meters. In this way, the radio station system is structured in a quasi-modular manner, and to save space can be installed in particularly advantageous locations. Thus, for example, the two radio stations of the radio station system can be installed in one room, such that they lie particularly advantageously in the radiation area of certain access network nodes.

In another embodiment, a radio station system in accordance with the contemplated embodiments is also installed on board a transport, for example, a vehicle, a ship, an aircraft or a train. Advantageously, the two radio stations can be located at different points in the transport, as far away from each other as possible. The first and second radio station, for example, can thus each be located in an aircraft or a train in different end regions of the train or of the aircraft. In this way, a particularly wide coverage area for radio signals from access network nodes is attainable, and optimum and continuous user data transmission can be achieved even in the case of a relatively rapid movement of the transport.

The object of the present invention is likewise achieved by a method for operating a radio station system in accordance with the disclosed embodiments, where during the existence of an active radio link between a first radio station and a first access network node, a second radio station at least at times identifies available access network nodes in the wireless network for the radio station system. Here, too, the occasional identification can, for example, occur at regular intervals or, for example, according to a predefined or a predefinable fixed or variable time pattern. Such an identification process can, for example, also occur if a standby radio link has already been set up according to the following description. As a result, it is possible for the standby radio links to be also dynamically adapted to the respective limiting conditions in the wireless network.

Here, too, there is the advantage that parallel to the existence of the active radio link between the first radio station and the first access network node, access network nodes already available are identified, and a possible switchover of the active radio link to a further radio link, for example, upon loss or deterioration of the active radio link, can thus be more rapidly achieved.

After or during the aforementioned identification of the available access network nodes, a preferred access network node can be determined from the identified available access network nodes in the radio station system, i.e., in the second radio station, and a standby connection built up with the preferred access network nodes. Here, the standby radio link is set up such that at least during the existence of the active radio link between the first radio station and the first access network node no user data is exchanged via the standby radio link. Nevertheless, radio communication control data and/or authentication-data, for example, can be transmitted or exchanged over the standby radio link.

Here, the identification of the available access network node, the determining of the preferred access network nodes and the setting-up of the standby connection can, for example, be configured as explained at another point in the present description.

In this way, the transfer of the radio station system from the active radio link to another radio link can be further accelerated, as a standby radio link is already built up with the second radio station, while the active radio link still exists and thus this relatively time-consuming connection set-up, i.e., if an authentication (for example, according to IEEE 802.11i Standard, for example, also with a “RADIUS server”) is involved, can already be undertaken during the existence of the active radio link.

Subsequently, the radio station system, i.e., the second radio station, can then compare a quality of the active radio links with a quality of the standby radio link. Here, too, the determination of the qualities of the respective radio link and their comparison can occur in accordance with the contemplated embodiments.

Alternatively or thereafter, the radio station system, i.e., the second radio station, can select a particularly preferred radio link from the active radio link and the standby radio link. This selection can also, for example, occur in accordance with the presently described embodiments.

Subsequently to the aforementioned steps, or during one of the aforementioned steps, it can furthermore be provided that the second radio station converts the standby radio link to a further active radio link for the transmission of user data to the preferred access network node, where furthermore the first radio station terminates the active radio link to the first access network node or converts the active radio link into a further standby radio link in accordance with the described embodiments, or furthermore at least terminates the user data transmission over this radio link.

This conversion or “handover” can, for example, then occur, if the quality of the standby radio link exceeds the quality of the active radio link or has exceeded a particular predefined or predefinable period of time, and/or if the preferred radio link corresponds to the standby radio link.

Here, too, the specified criteria mean that a “handover” of the active radio link to the first access network node to the further active radio link to the preferred access network node then occurs if a user data transmission over a converted standby radio link appears to be more suitable for the radio station system than user data transmission over the existing active radio link. This handover can also be further in accordance with the described embodiments.

After the aforementioned handover, the first radio station can then at least at times identify available access network node in the wireless networks for the radio station system. Consequently, after the handover, the first and second radio station in the radio station system have effectively swapped roles, so that after a handover too, the radio station system has the same advantageous properties as before.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will now be illustrated by way of example with reference to the attached figure, in which:

FIG. 1 is a schematic block diagram of a WLAN network with a dual client in accordance with the invention; and

FIG. 2 is a flow chart of the method in accordance with an embodiment of the invention.

### DETAILED DESCRIPTION OF THE PRESENTLY PREFERRED EMBODIMENTS

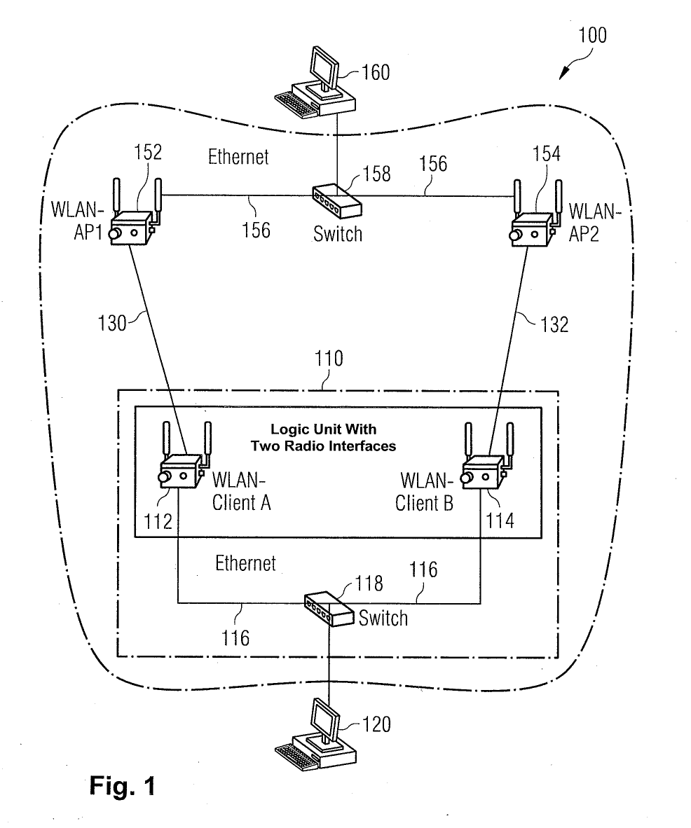

FIG. 1 is a wired local area network (WLAN) 100 in accordance with the Standard IEEE 802.11 for the transmission of user data from a first communication station 120 to a second communication station 160. The WLAN network 100 comprises a dual client 110, which comprises a first “WLAN client A” 112 and a second “WLAN client B” 114, which in turn are connected via Ethernet lines 116 and an interposed so-called “switch” 118.

Furthermore, a first “access point” 152 (WLAN-AP1) and a second access point 154 (WLAN-AP2) are provided in the WLAN network 100, which are connected via an Ethernet-connection 156 and an interposed switch 158. Furthermore, an active radio link 130 exists between the first WLAN client 112 and the first access point 152.

In the status of the WLAN network 100 represented in FIG. 1, user data is transmitted from the first communication arrangement 120 to the switch 118 in the dual client 110 and then forwarded over the active radio link 130 from the first WLAN client 112 to the first WLAN access point 152, whereafter it is then forwarded through the switch 158 in the fixed part of the Ethernet to the second communication station 160.

Parallel to the active radio link 130 between the first WLAN client 112 and the first access point 152, the second WLAN client 114 has scanned all available radio channels in the WLAN network 100, and by analyzing the signals received from the first and second access points 152, 154 identified for which the second access point 154 is the preferred access point. The second WLAN client 114 has then set up a standby connection 132 to the second access point 154.

At regular intervals, the first WLAN client 112 of the dual client 110 now transmits the quality of the active radio link 130 to the second WLAN client 114, which compares this with the quality of its standby connection 132.

If, for example, the second WLAN client 114 now ascertains that the quality of the standby connection 132 is better or also permanently better than that of the active radio link 130, the second WLAN client 114 initiates a handover of the dual client 110 to the second access point 154.

This then occurs such that the standby-connection 132 is converted or extended into an active connection for transmission of the user data, while the active connection 130 of the first WLAN client 112 to the first access point 152 is converted into a further standby connection or even interrupted. Accordingly, the user data-transmission from the first communication station partner 120 to the second communication station 160 then occurs exclusively over the former standby connection 132 and now new active user data radio link.

Such a switchover can, for example, proceed as follows:

1. The second WLAN client 114 decides to initiate a switchover and informs the first WLAN client 112;

2. The first WLAN client 112 interrupts the forwarding of user data packets, switches to a standby connection and begins the search for other available WLAN access points within range;

3. The first WLAN client 112 transfers its forwarding table (Bridge-FDB) to the second WLAN client 114;

4. The second WLAN client 114 transmits a management message to the second access point 154 to activate the standby connection 132. This management message contains, for example, the addresses of the connected users in the mobile network;

5. The second WLAN client 114 confirms to the first WLAN client 112 the successful activation of the former standby connection 132 and updates corresponding forwarding tables of switches connected within the fixed network, such as the switch 158;

6. The second WLAN client 114 updates corresponding forwarding tables in the switch 118 in the dual client 110 with the aid of the forwarding table which it has received from the first access point 152; and

7. The second WLAN client 114 starts the forwarding of user data packets to the second access point 154.

The spatial separation of the two WLAN clients 112, 114 of the dual client 110 represented in FIG. 1 gives rise to the advantage that as a result of the different coverage areas of the antennae a larger radio field can be covered. This enables an increase in the potential number of available WLAN access points 152, 154, which are located within range of the dual client 110 at a particular point in time.

The method described in the present description and the corresponding devices in combination offer for example some, several or all of the advantages set out below:

1. The available bandwidth is more effectively utilized because of the separation between user data transmission and the search for available WLAN access points;

2. The connection quality at any point in time is improved by frequently or permanently comparing the signal quality between an active and a standby radio link;

3. A handover can be performed with reduced interrupt time, even when authentication methods, such as in accordance with IEEE 802.11i are employed and/or when using a “RADIUS server”;

4. The coverage area of the WLAN dual clients can be extended by a possible spatial separation of the WLAN clients in the WLAN dual client 110; and

5. A possible connection redundancy exists in case of the failure of one of the WLAN clients.

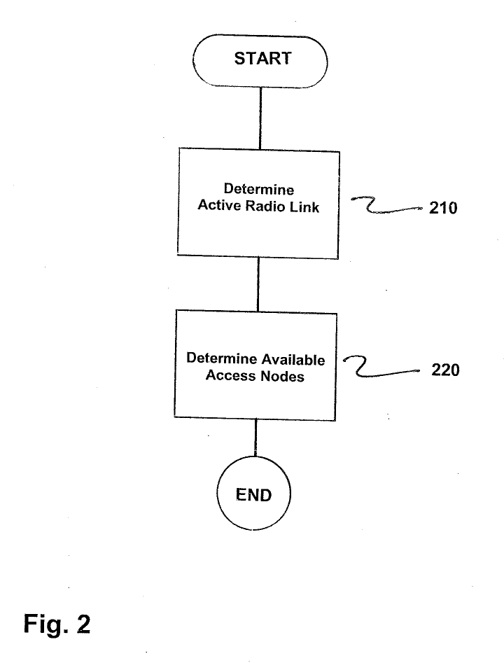

FIG. 2 is flow chart of a method for operating a radio station system for a wireless network, where the radio station system includes a first radio station connected to a first access network node through an active radio link for exchanging user data, and includes a second radio station connected to the first radio station over a communication interface. The method comprises determining, by the second radio station, an existence of an active radio link between the first radio station and the first access network node, as indicated in step 210. Next, at least at times available access network nodes in the wireless network are identified by the second radio station for the radio station system during the existence of the active radio link between the first radio station and the first access network node, as indicated in step 220.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A radio station system for a wireless network having at least two access network nodes, a first access network node of the at least two access network nodes in the wireless network being assigned to the radio station system and the radio station system being connected to the first access network node over an active radio link for transmitting user data, the radio station system comprising:
a first radio station connected to the first access network node through the active radio link for exchanging the user data; and
a second radio station connected to the first radio station over a communication interface;
wherein during existence of the active radio link between the first radio station and the first access network node, the second radio station one of transmits and exchanges no user data over a radio link with an access network node in the wireless network; and
wherein at least at times during the existence of the active radio link between the first radio station and the first access network node, the second radio station identifies available access network nodes of the at least two access network nodes in the wireless network for the radio station system.

2. The radio station system as claimed in claim 1, wherein the second radio station is configured to determine a preferred access network node from the identified available access network nodes and to set up a standby radio link with the preferred access network node, the standby radio link being set up such that at least during the existence of the active radio link between the first radio station and the first access network node no user data is exchanged over the standby radio link.

3. The radio station system as claimed in claim 2, wherein the second radio station is configured to compare a quality of the active radio link with a quality of the standby radio link.

4. The radio station system as claimed in claim 2, wherein the second radio station is configured to select a preferred radio link from the one of the active radio link and the standby radio link.

5. The radio station system as claimed in claim 3, wherein the second radio station is configured to select a preferred radio link from the one of the active radio link and the standby radio link.

6. The radio station system as claimed in claim 3, wherein the radio station system is configured and set up such that the standby radio link is converted into a further active radio link for transmitting the user data from the second radio station to the preferred access network node, the active radio link between the first radio station and the first access network node is at least one of terminated and converted to a further standby radio link, if at least one of:
the quality of the standby radio link one of exceeds and has exceeded the quality of the active radio link, and
the preferred radio link corresponds to the standby radio link.

7. The radio station system as claimed in claim 6, wherein communication properties of the first radio station correspond to communication properties of the second radio station; and
wherein after at least one of termination of the active radio link and conversion of the active radio link into the further standby radio link to the first access network node, the first radio station one of transmits and exchanges no further user data over a radio link with an access network node in the wireless network and at least at times identifies the available access network nodes of the at least two access network nodes in the wireless network for the radio station system.

8. The radio station system as claimed in claim 1, wherein antennae assigned to the first and second radio stations are one of arranged at a distance from each other and configured to have different radiation characteristics.

9. The radio station system as claimed in claim 1, wherein the first and second radio stations each have a housing and the housings of the first and second radio stations are at a distance from each other.

10. The radio station system as claimed in claim 1, wherein the first and second radio stations are set up such that communication properties of the first and second radio stations in the wireless network are identical.

11. The radio station system as claimed in claim 1, wherein the radio station system comprises at least one of an automation, real time and/or industrial wireless network.

12. The radio station system as claimed in claim 1, wherein the communication interface is an Ethernet interface.

13. A vehicle having a radio station system as claimed in claim 1, wherein the first and second radio station are arranged at different locations in the vehicle.

14. A method for operating a radio station system for a wireless network, the radio station system having a first radio station connected to a first access network node of a wireless network through an active radio link for exchanging user data, and having a second radio station connected to the first radio station over a communication interface, the method comprising:
determining, by the second radio station, an existence of an active radio link between the first radio station and the first access network node; and
a) identifying, by the second radio station, at least at times available access network nodes in the wireless network for the radio station system during the existence of the active radio link between the first radio station and the first access network.

15. The method as claimed in claim 14, further comprising after or during method step a):
b) determining, by the second radio station, a preferred access network node from the available access network nodes identified during step a) and setting up, by the second radio station, a standby radio link with the determined preferred access network node;
wherein the standby radio link is set up such that at least during the existence of the active radio link between the first radio station and the first access network node, no user data is exchanged over the standby radio link.

16. The method as claimed in claim 15, further comprising after step b):
c) comparing, by the second radio station, a quality of the active radio link with a quality of the standby radio link.

17. The method as claimed in claim 16, further comprising after step c):
d) selecting, by the second radio station, a preferred radio link from the active radio link and the standby radio link.

18. The method as claimed in claim 16, further comprising after step d):
e) converting, by the second radio station, the standby radio link into a further active radio link for transmitting the user data to the preferred access network node, the first radio station at least one of terminating the active radio link to the first access network node and converts the active radio link to the first access network node into a further standby radio link, if at least one of the quality of the standby radio link one of exceeds and has exceeded the quality of the active radio link and the preferred radio link corresponds to the standby radio link.

19. The method as claimed in claim 15, further comprising, after or during step e):
f) identifying, by the first radio station, at least at times available access network nodes in the wireless network for the radio station system.
